(19) United States
(12) Patent Application Publication
(10) Pub. No.: US 2026/0029072 A1
(43) Pub. Date: Jan. 29, 2026

(54) VACUUM HOSE AND METHOD OF MANUFACTURING THE SAME

(71) Applicant: CPA Pool Products, Blainville (CA)

(72) Inventor: Guoxin Lv, Anwen Town (CN)

(21) Appl. No.: 18/923,622

(22) Filed: Oct. 22, 2024

(30) Foreign Application Priority Data
Jul. 23, 2024 (CN) 202421754666.1

(51) Int. Cl. F16L 11/115; B29C 48/00; B29C 48/09; B29C 48/13; B29K 23/00; B29L 23/00

(52) U.S. Cl. CPC F16L 11/115; B29C 48/0021; B29C 48/09; B29C 48/13; B29K 2023/0633; B29K 2023/065; B29K 2023/083; B29L 2023/005

(57) ABSTRACT

The vacuum hose includes an inner tube body and an outer tube body sleeved over the inner tube body. The inner tube body has a spiral structure defined by a first contact portion and a second contact portion. One end of the second contact portion is connected to one end of the first contact portion, and the other end of the second contact portion is in contact with the other end of the first contact portion. The outer tube body has a spiral structure defined by a covering portion. The covering portion contacts the first contact portion and the second contact portion and covers the end of the second contact portion in contact with the end of the first contact portion.

### CROSS-REFERENCE TO RELATED APPLICATIONS

This application claims priority to Chinese Patent Application No. 202421754666.1, filed Jul. 23, 2024, the entire disclosure of which is hereby incorporated by reference.

### FIELD OF THE DISCLOSURE

This disclosure relates to flexible tubing and, more particularly, to flexible tubing for a vacuum hose.

### BACKGROUND OF THE DISCLOSURE

Polyethylene (PE) pipes are commonly used in various applications due to their excellent resistance to most household and industrial chemicals. PE pipes may also generally be lightweight and flexible, depending on the thickness and geometry of the pipe. For example, a PE pipe with a corrugated design can provide flexibility for use as a vacuum hose.

Typical extrusion processes can be used to produce corrugated PE pipes, however, these pipes have low strength and are prone to hardening in winter, making them very susceptible to damage. This can lead to water leakage, air leakage, or impurities entering the pipes, greatly affecting their effectiveness in various applications. For example, such leaks can cause a vacuum hose to fail underwater in pool cleaning applications. While PE plastic could be replaced with stronger materials to reduce leakage risk, this would increase the production cost and reduce the overall flexibility of the vacuum hose. While composite materials could be used to further balance the strength and flexibility, extruding materials with different extrusion constants can result in a non-uniform distribution of the materials in the vacuum hose and can sill be prone to leakage.

Therefore, what is needed is an improved vacuum hose and method of making the same.

### BRIEF SUMMARY OF THE DISCLOSURE

An embodiment of the present disclosure provides a vacuum hose. The vacuum hose may comprise an inner tube body having a spiral structure defined by a first contact portion and a second contact portion. One end of the second contact portion may be connected to one end of the first contact portion, and the other end of the second contact portion may be in contact with the other end of the first contact portion. The vacuum hose may further comprise an outer tube body having a spiral structure defined by a covering portion. The outer tube body may be sleeved over the inner tube body such that the covering portion may contact the first contact portion and the second contact portion and may cover the end of the second contact portion in contact with the end of the first contact portion.

In some embodiments, the spiral structure of the inner tube body may be further defined by a connecting portion provided between the first contact portion and the second contact portion. The first contact portion may be connected to the second contact portion through the connecting portion.

In some embodiments, the spiral structure of the outer tube body may be further defined by a first bending portion and a second bending portion. The covering portion may extend and bend toward the first contact portion to form the first bending portion, and the covering portion may extend and bend toward the second contact portion to form the second bending portion.

In some embodiments, the first bending portion may be in contact with the first contact portion, and the second bending portion may be in contact with the second contact portion.

In some embodiments, the first bending portion in contact with the first contact portion may be bonded to the first contact portion, and the second bending portion in contact with the second contact portion may be bonded to the second contact portion.

In some embodiments, the end of the second contact portion in contact with the end of the first contact portion may be bonded to the end of the first contact portion.

In some embodiments, the covering portion in contact with the first contact portion and the second contact portion may be bonded to at least one of the first contact portion and the second contact portion.

In some embodiments, the inner tube body and the outer tube body may be comprised of different materials.

In some embodiments, the inner tube body may be comprised of a low-density polyethylene and EVA copolymer, and the outer tube body may be comprised of a high-density polyethylene material.

Another embodiment of the present disclosure provides a method of manufacturing a vacuum hose. The method may comprise: forming an inner tube body having a spiral structure defined by a first contact portion and a second contact portion, wherein one end of the second contact portion is connected to one end of the first contact portion, and the other end of the second contact portion is in contact with the other end of the first contact portion; forming an outer tube body having a spiral structure defined by a covering portion; and combining the outer tube body with the inner tube body such that the covering portion contacts the first contact portion and the second contact portion and covers the end of the second contact portion in contact with the end of the first contact portion.

In some embodiments, the spiral structure of the inner tube body may be further defined by a connecting portion provided between the first contact portion and the second contact portion, with the first contact portion being connected to the second contact portion through the connecting portion, and forming the inner tube body may comprise extruding the spiral structure defined by the end of first contact portion and the end of the second contact portion connected through the connecting portion.

In some embodiments, forming the inner tube body may further comprise bonding the end of the second contact portion in contact with the end of the first contact portion to the end of the first contact portion.

In some embodiments, the spiral structure of the outer tube body may be further defined by a first bending portion and a second bending portion, with the covering portion extending and bending toward the first contact portion to form the first bending portion and the covering portion extending and bending toward the second contact portion to form the second bending portion, and forming the outer tube body may comprise extruding the spiral structure of the outer tube body defined by the covering portion, the first bending portion extending from one end the covering portion, and the second bending portion extending from the other end of the covering portion.

In some embodiments, combining the outer tube body with the inner tube body may comprise: covering the end of the second contact portion in contact with the end of the first contact portion with the covering portion; contacting the first contact portion with the first bending portion; and contacting the second contact portion with the second bending portion.

In some embodiments, combining the outer tube body with the inner tube body may further comprise bonding the covering portion to at least one of the first contact portion and the second contact portion.

In some embodiments, combining the outer tube body with the inner tube body may further comprise: bonding the first bending portion to the first contact portion; and bonding the second bending portion to the second contact portion.

### DESCRIPTION OF THE DRAWINGS

For a fuller understanding of the nature and objects of the disclosure, reference should be made to the following detailed description taken in conjunction with the accompanying drawings, in which:

FIG. 1 is a perspective view of a vacuum hose according to an embodiment of the present disclosure;

FIG. 2 is an exploded perspective view of the vacuum hose of FIG. 1;

FIG. 3 is a side view of the vacuum hose of FIG. 1;

FIG. 4 is a section view of the vacuum hose along line A-A of FIG. 3;

FIG. 5 is a detail view of the vacuum hose in part B of FIG. 4;

FIG. 6 is an exploded side view of the vacuum hose of FIG. 3;

FIG. 7 is a second view of the vacuum hose along line C-C of FIG. 6;

FIG. 8 is a flowchart of a method of manufacturing a vacuum hose according to an embodiment of the present disclosure;

FIG. 9 is a flowchart of a method of manufacturing a vacuum hose according to another embodiment of the present disclosure;

FIG. 10 is a flowchart of a method of manufacturing a vacuum hose according to another embodiment of the present disclosure; and

FIG. 11 is a flowchart of a method of manufacturing a vacuum hose according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

It should be noted that all directional indications (such as up, down, left, right, front, back, etc.) in the embodiments of the present disclosure are only used to explain the relative position relationship and motion situation between components in a specific posture (as shown in the attached figure). If the specific posture changes, the directional indication also changes accordingly.

In addition, the descriptions related to “first”, “second”, etc. are only used for descriptive purposes and cannot be understood as indicating or implying their relative importance or implying the quantity of technical features indicated. Therefore, the features limited to “first” and “second” can explicitly or implicitly include at least one of these features. In the present disclosure, “multiple” means at least two, such as two, three, etc., unless otherwise specified.

In the present disclosure, unless otherwise specified and limited, the terms “connection”, “fixed”, etc. should be broadly understood, for example, “fixed” can be a fixed connection, a detachable connection, or a whole; It can be a mechanical connection or an electrical connection; It can be directly connected or indirectly connected through an intermediate medium, it can be the internal connection of two components or the interaction relationship between two components, unless otherwise specified. For ordinary technical personnel in this field, the specific meanings of the above terms in the present disclosure can be understood based on specific circumstances.

In addition, the technical solutions of various embodiments of the present disclosure can be combined with each other, but must be based on what ordinary technicians in the art can achieve. When the combination of technical solutions conflicts or cannot be achieved, it should be considered that the combination of such technical solutions does not exist and is not within the protection scope required by the present disclosure.

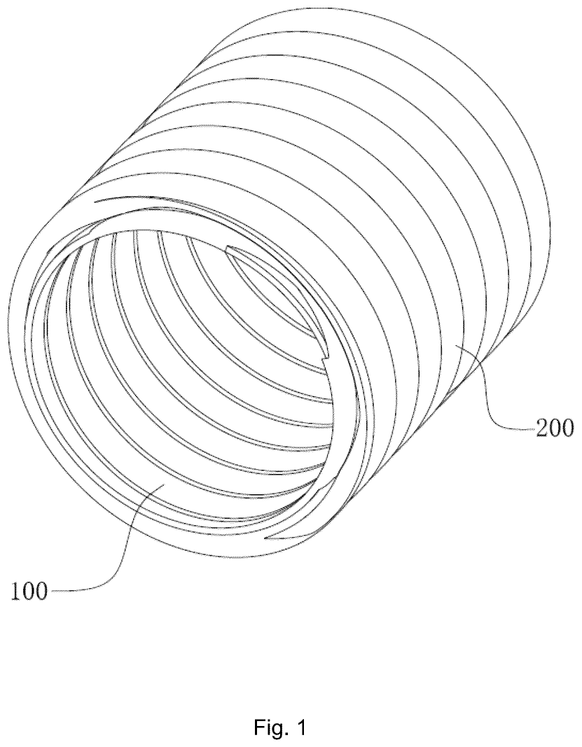

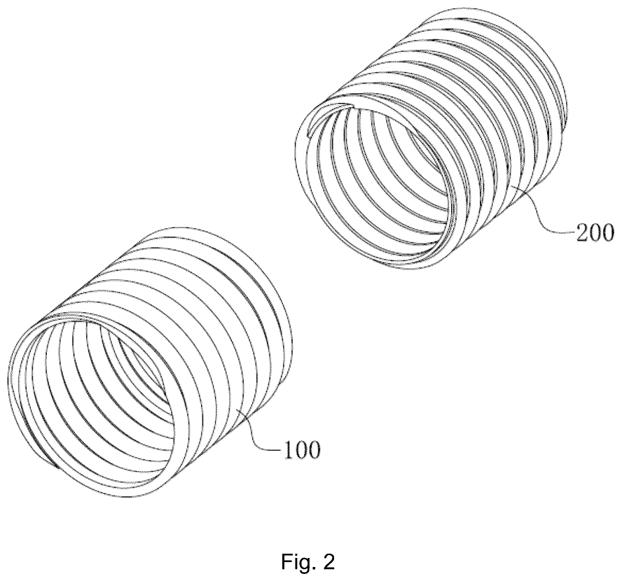

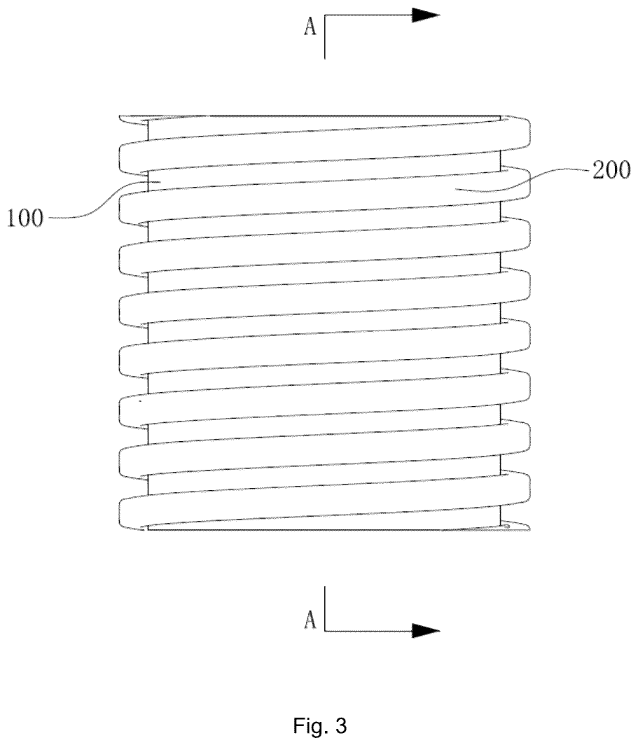

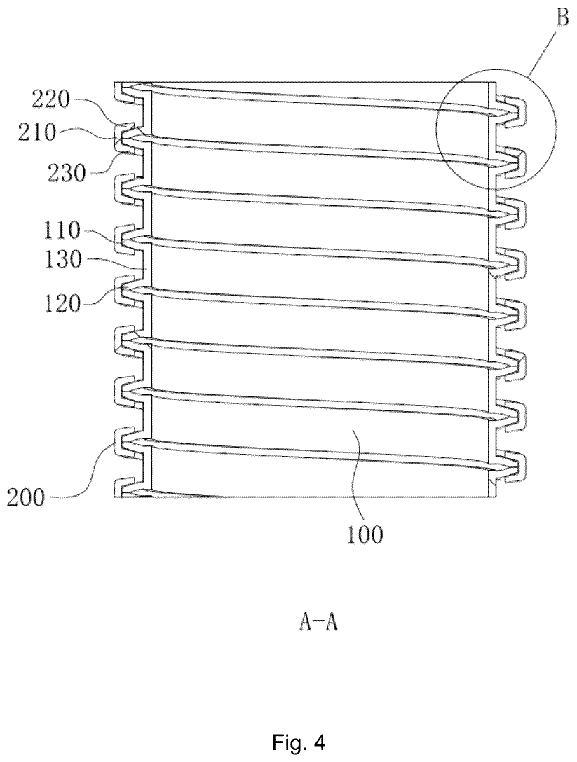

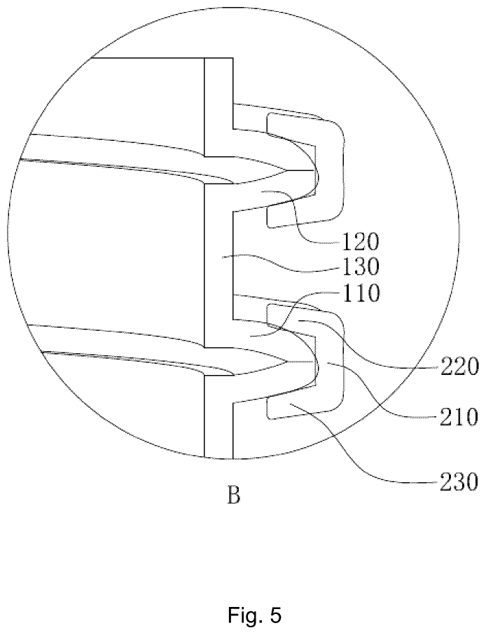

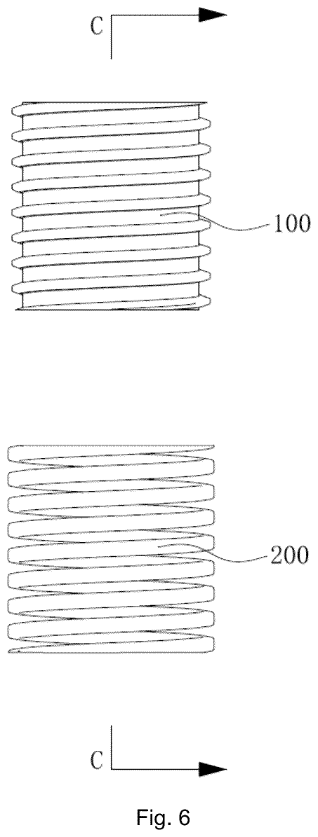

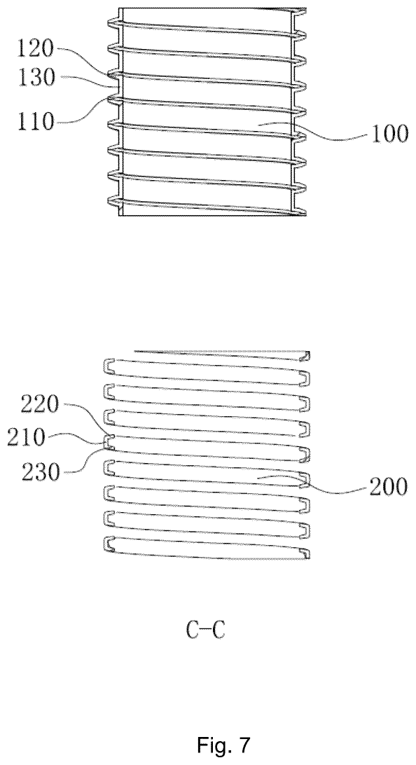

An embodiment of the present disclosure provides a vacuum hose comprising an inner tube body 100 and an outer tube body 200, as shown in FIGS. 1-7.

The inner tube body 100 may have a spiral structure defined by a first contact portion 110 and a second contact portion 120. One end of the second contact portion 120 may be connected to one end of the first contact portion 110, and the other end of the second contact portion 120 may be in contact with the other end of the first contact portion 110.

The outer tube body 200 may have a spiral structure defined by a covering portion 210. The outer tube body 200 may be sleeved over the inner tube body 100 such that the covering portion 210 contacts the first contact portion 110 and the second contact portion 120 and covers the end of the second contact portion 120 in contact with the end of the first contact portion 110.

According to the present disclosure, the vacuum hose may be divided into two layers: the inner tube body 100 and the outer tube body 200. In particular, the first contact portion 110 and the second contact portion 120 on both sides of the inner pipe body 100 are arranged in a spiral pattern to form the main body of the vacuum hose, and the end of the second contact portion 120 in contact with the end the first contact portion 110 is covered by the covering portion 210, which may provide high strength and good sealing performance for the vacuum hose.

In some embodiments, the spiral structure of the inner tube body 100 may be further defined by a connecting portion 130. The connecting portion 130 may be between the first contact portion 110 and the second contact portion 120. The first contact portion 110 may be connected to the second contact portion 120 through the connecting portion 130. In particular, the first contact portion 110 may be connected to the second contact portion 120 through the connecting portion 130, extending the axial length of the vacuum hose and facilitating the fixation or connection of the covering portion 210 on both sides, so that the outer tube body 200 can be fixed relative to the inner tube body 100.

In some embodiments, the spiral structure of the outer tube body 200 may be further defined by a first bending portion 220 and a second bending portion 230. The covering portion 210 may extend and bend towards the first contact portion 110 to form the first bending portion 220, and the covering portion 210 may extend and bend towards the second contact portion 120 to form the second bending portion 230. For example, the first bending portion 220 may be in contact with the first contact portion 110, and the second bending portion 230 may be in contact with the second contact portion 120. With the covering portion 210 extending and bending towards the first contact portion 110 to form the first bending portion 220, and the covering portion 210 extending and bending towards the second contact portion 120 to form the second bending portion 230, the two sides of the covering portion 210 may be positioned separately to fix the outer tube body 200 relative to the inner tube body 100.

In some embodiments, the second contact portion 120 may be bonded to the contact portion of the first contact portion 110. With the second contact portion 120 bonded to the first contact portion 110, the strength of the vacuum hose may be further enhanced, which can prevent damage caused by water leakage or impurities entering the vacuum hose.

In some embodiments, the covering portion 210 in contact with the first contact portion 110 and the second contact portion 120 may be bonded at least one of the first contact portion 110 and the second contact portion 120. For example, the contact part between the covering part 210 and the first contact part 110 may be bonded, and/or the contact part between the covering part 210 and the second contact part 120 may be bonded, which can strengthen the positioning of the inner tube body 100 relative to the outer tube body 200, further enhance the strength of the vacuum hose, and prevent damage caused by water leakage or impurities entering the vacuum hose.

In some embodiments, the first bending portion 220 in contact with the first contact portion 110 may be bonded to the first contact portion 110, and the second bending portion 230 in contact with the second contact portion 120 may be bonded to the second contact portion 120. For example the contact part between the first bending part 220 and the first contact part 110 may be bonded, and the contact part between the second bending part 230 and the second contact part 120 may be bonded, which can strengthen the positioning of the inner tube body 100 relative to the outer tube body 200, further enhance the strength of the vacuum hose, and prevent damage caused by water leakage or impurities entering the vacuum hose.

In some embodiments, the inner tube body 100 and the outer tube body 200 may be comprised of different materials. For example the inner tube body 100 may be comprised of a low-density polyethylene and EVA copolymer, and the outer tube body 200 may be comprised of a high-density polyethylene material. The composite application of the inner tube body 100 and the outer tube body 200 made of different materials may reduce the production cost of the vacuum hose while improving its strength and flexibility.

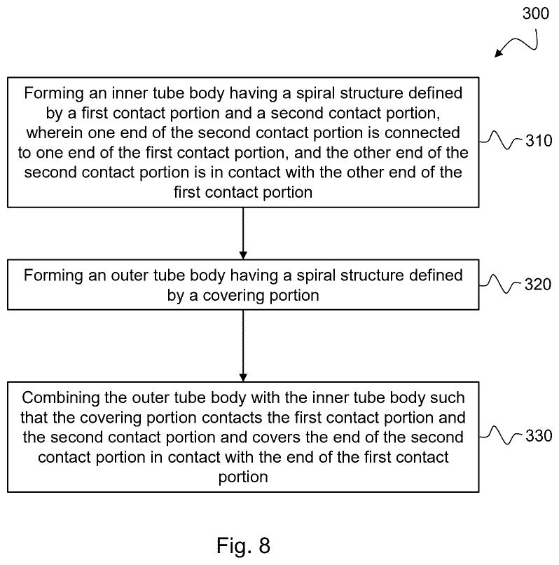

Another embodiment of the present disclosure provides a method 300 of manufacturing a vacuum hose. As shown in FIG. 8, the method 300 may comprise the following steps.

At step 310, an inner tube body having a spiral structure defined by a first contact portion and a second contact portion is formed. One end of the second contact portion may be connected to one end of the first contact portion, and the other end of the second contact portion may be in contact with the other end of the first contact portion. The inner tube body formed in step 310 may be the inner tube body 100 described above.

At step 320, an outer tube body having a spiral structure defined by a covering portion is formed. The outer tube body formed in step 320 may be the outer tube body 200 described above.

At step 330, the outer tube body is combined with the inner tube body such that the covering portion contacts the first contact portion and the second contact portion and covers the end of the second contact portion in contact with the end of the first contact portion.

According to the method 300, the vacuum hose may be divided into two layers, the inner tube body and the outer tube body, with the first contact part and the second contact part on both sides of the inner tube body being arranged in a spiral pattern to form the main body of the vacuum hose. Since the covering portion of the outer tube body covers end of the second contact portion in contact with the first contact portion, the vacuum hose may be formed having high strength, good scaling, and flexibility. The method 300 may also allow a composite vacuum hose to be produced, in which the inner tube body and the outer tube body may be comprised of different materials, which can improve the strength and flexibility of the vacuum hose.

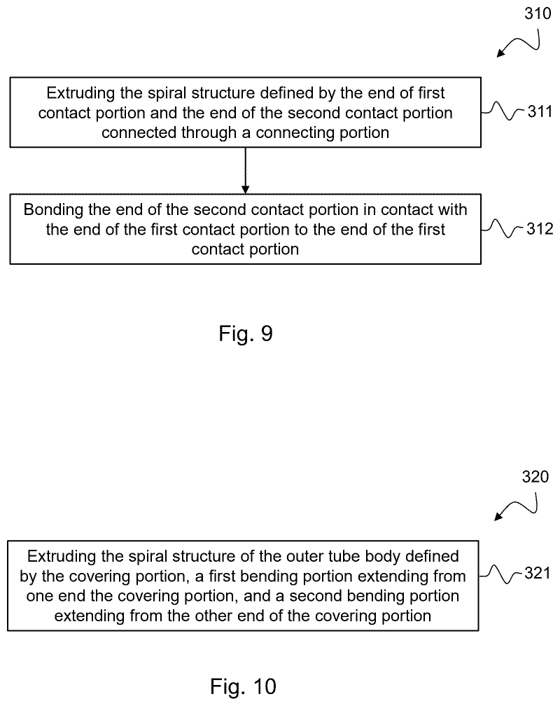

In some embodiments, step 310 may comprise step 311, shown in FIG. 9. At step 311, the spiral structure defined by the end of first contact portion and the end of the second contact portion connected through a connecting portion is extruded. The first contact portion may be connected to the second contact portion through the connecting portion, which extends the axial length of the vacuum hose and can facilitate the fixation or connection of both sides of the covering portion, such that the outer tube body may be fixed relative to the inner tube body.

In some embodiments, step 310 may further comprise step 312, shown in FIG. 9. At step 312, the end of the second contact portion in contact with the end of the first contact portion is bonded to the end of the first contact portion. With the second contact portion bonded to the first contact portion, the strength of the vacuum hose may be further enhanced, which can prevent damage caused by water leakage or impurities entering the vacuum hose.

In some embodiments, step 320 may comprise step 321, shown in FIG. 10. At step 321, the spiral structure of the outer tube body defined by the covering portion, the first bending portion extending from one end the covering portion, and the second bending portion extending from the other end of the covering portion is extruded.

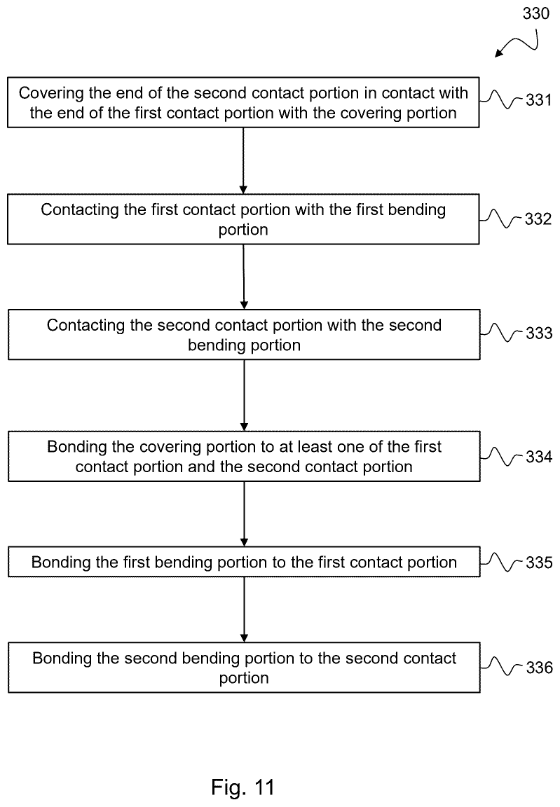

In some embodiments, step 330 may comprise the following steps, shown in FIG. 11. At step 331, the end of the second contact portion in contact with the end of the first contact portion is covered with the covering portion. At step 332, the first contact portion is contacted with the first bending portion. At step 333, the second contact portion is contacted with the second bending portion. 3. Although steps 331 to 333 are shown sequentially in FIG. 11, it should be understood that the order of these steps may vary from the illustrated order. With the covering portion extending and bending towards the first contact portion to form the first bending portion, and the covering part extending and bending towards the second contact portion to form the second bending portion, the outer tube body may be fixed relative to the inner tube body.

In some embodiments, step 330 may further comprise the following steps, shown in FIG. 11. At step 334, the covering portion is bonded to at least one of the first contact portion and the second contact portion. At step 335, the first bending portion is bonded to the first contact portion. At step 336, the second bending portion is bonded to the second contact portion. Although steps 334 to 336 are shown following steps 331 to 333 in FIG. 11, it should be understood that the order of these steps may vary from the illustrated order. For example, the steps 334 to 336 may be performed after the corresponding ones of steps 331 to 333 (i.e., after the first contact portion is contacted with the first bending portion in step 332, the first bending portion is bonded to the first contact portion in step 335, etc.). With the covering portion being bonded to at least one of the first contact portion and the second contact portion, the first bending portion being bonded to the first contact portion, and/or the second bending portion being bonded to the second contact portion, the positioning of the inner tube body relative to the outer tube body can be strengthened, which can further improve the strength of the vacuum hose and prevent damage caused by water leakage or impurities entering the vacuum hose.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A vacuum hose comprising:
an inner tube body having a spiral structure defined by a first contact portion and a second contact portion, wherein one end of the second contact portion is connected to one end of the first contact portion, and the other end of the second contact portion is in contact with the other end of the first contact portion; and
an outer tube body having a spiral structure defined by a covering portion, wherein the outer tube body is sleeved over the inner tube body such that the covering portion contacts the first contact portion and the second contact portion and covers the end of the second contact portion in contact with the end of the first contact portion.

2. The vacuum hose of claim 1, wherein the spiral structure of the inner tube body is further defined by a connecting portion provided between the first contact portion and the second contact portion, with the first contact portion being connected to the second contact portion through the connecting portion.

3. The vacuum hose of claim 1, wherein the spiral structure of the outer tube body is further defined by a first bending portion and a second bending portion, with the covering portion extending and bending toward the first contact portion to form the first bending portion, and the covering portion extending and bending toward the second contact portion to form the second bending portion.

4. The vacuum hose of claim 3, wherein the first bending portion is in contact with the first contact portion, and the second bending portion is in contact with the second contact portion.

5. The vacuum hose of claim 4, wherein the first bending portion in contact with the first contact portion is bonded to the first contact portion, and the second bending portion in contact with the second contact portion is bonded to the second contact portion.

6. The vacuum hose of claim 1, wherein the end of the second contact portion in contact with the end of the first contact portion is bonded to the end of the first contact portion.

7. The vacuum hose of claim 1, wherein the covering portion in contact with the first contact portion and the second contact portion is bonded to at least one of the first contact portion and the second contact portion.

8. The vacuum hose of claim 1, wherein the inner tube body and the outer tube body are comprised of different materials.

9. The vacuum hose of claim 8, wherein the inner tube body is comprised of a low-density polyethylene and EVA copolymer, and the outer tube body is comprised of a high-density polyethylene material.

10. A method of manufacturing a vacuum hose comprising:
forming an inner tube body having a spiral structure defined by a first contact portion and a second contact portion, wherein one end of the second contact portion is connected to one end of the first contact portion, and the other end of the second contact portion is in contact with the other end of the first contact portion;
forming an outer tube body having a spiral structure defined by a covering portion; and
combining the outer tube body with the inner tube body such that the covering portion contacts the first contact portion and the second contact portion and covers the end of the second contact portion in contact with the end of the first contact portion.

11. The method of claim 10, wherein the spiral structure of the inner tube body is further defined by a connecting portion provided between the first contact portion and the second contact portion, with the first contact portion being connected to the second contact portion through the connecting portion, and forming the inner tube body comprises:
extruding the spiral structure defined by the end of first contact portion and the end of the second contact portion connected through the connecting portion.

12. The method of claim 11, wherein forming the inner tube body further comprises:
bonding the end of the second contact portion in contact with the end of the first contact portion to the end of the first contact portion.

13. The method of claim 10, wherein the spiral structure of the outer tube body is further defined by a first bending portion and a second bending portion, with the covering portion extending and bending toward the first contact portion to form the first bending portion and the covering portion extending and bending toward the second contact portion to form the second bending portion, and forming the outer tube body comprises:
extruding the spiral structure of the outer tube body defined by the covering portion, the first bending portion extending from one end the covering portion, and the second bending portion extending from the other end of the covering portion.

14. The method of claim 13, wherein combining the outer tube body with the inner tube body comprises:
covering the end of the second contact portion in contact with the end of the first contact portion with the covering portion;
contacting the first contact portion with the first bending portion; and
contacting the second contact portion with the second bending portion.

15. The method of claim 14, wherein combining the outer tube body with the inner tube body further comprises:
bonding the covering portion to at least one of the first contact portion and the second contact portion.

16. The method of claim 14, wherein combining the outer tube body with the inner tube body further comprises:
bonding the first bending portion to the first contact portion; and
bonding the second bending portion to the second contact portion.
